(19) United States
(12) Patent Application Publication
(10) Pub. No.: US 2023/0337004 A1
(43) Pub. Date: Oct. 19, 2023

(54) METHOD FOR SECURED AND EFFICIENT SUBSCRIBER INFORMATION TRANSMISSION FOR HTTPS TRANSACTIONS

(71) Applicant: T-MOBILE INNOVATIONS LLC, Overland Park, KS (US)

(72) Inventors: Salvador Mendoza, Issaquah, WA (US); Boris Antsev, Bothell, WA (US)

(21) Appl. No.: 17/981,099

(22) Filed: Nov. 4, 2022

Related U.S. Application Data
(60) Provisional application No. 63/330,854, filed on Apr. 14, 2022.

(51) Int. Cl. H04W 12/72; H04W 8/20; H04L 67/02; H04L 67/141; H04W 12/08

(52) U.S. Cl. CPC H04W 12/72; H04W 8/205; H04L 67/02; H04L 67/141; H04W 12/08

(57) ABSTRACT

Systems and methods are provided for transmitting subscriber information via HTTPS. Upon a UE initiating an HTTPS transaction to a server, the gateway reads an SNI header of the HTTPS transaction or a destination IP address of the server. If the SNI header or the destination IP address in the HTTPS transaction matches a pre-configured SNI header or destination IP address that requires subscriber information, the gateway copies a portion of an HTTPS message corresponding to the HTTPS transaction. The gateway initiates a secured connection to the server via HTTPS and forwards the subscriber information to the server, including the portion of the HTTPS message used to correlate the subscriber information to the original HTTPS transaction. Upon successfully correlating the subscriber information to the original HTTPS transaction, an acknowledgement is received that the HTPPS transaction is successful.

### CROSS-REFERENCE TO RELATED APPLICATIONS

This application claims the benefit of U.S. Provisional Application No. 63/330,854, filed Apr. 14, 2022, the contents of which are hereby incorporated herein in their entireties by reference.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for transmitting subscriber information via HTTPS. More particularly, in aspects set forth herein, systems and methods allow mobile operators to pass subscriber information from the core network's gateway network element to trusted partners for HTTPS transactions. As a result, subscriber information can be shared with trusted partners for all types of data sessions, including those that go through a network address translation (NAT) node. Initially, upon a UE initiating an HTTPS transaction to a server, the gateway reads an SNI header of the HTTPS transaction or a destination IP address of the server. If the SNI header or the destination IP address in the HTTPS transaction matches a pre-configured SNI header or destination IP address that requires subscriber information, the gateway copies a portion of an HTTPS message corresponding to the HTTPS transaction. The gateway initiates a secured connection to the server via HTTPS and forwards the subscriber information to the server, including the portion of the HTTPS message used to correlate the subscriber information to the original HTTPS transaction. Upon successfully correlating the subscriber information to the original HTTPS transaction, an acknowledgement is received that the HTPPS transaction is successful.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed; herein;

FIG. 2 illustrates an exemplary subscriber engine, in accordance with aspects

FIG. 3 depicts a flow diagram of a method of a call flow for subscriber information transmission via HTTP header enrichment;

FIG. 4 depicts an HTTP header enrichment snapshot;

FIG. 5 depicts a flow diagram of a method of a call flow for subscriber information transmission via HTTPS header enrichment, in accordance with aspects herein;

FIG. 6 depicts an exemplary HTTPS client hello and 5-tuple snapshots, in accordance with aspects herein; and

FIG. 7 depicts a diagram of an exemplary computing environment suitable for use in implementations of the present disclosure.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
PC Personal Computer
PCS Personal Communications Service
PDA Personal Digital Assistant
RAM Random Access Memory
RET Remote Electrical Tilt
RF Radio-Frequency
RFI Radio-Frequency Interference
R/N Relay Node
RNR Reverse Noise Rise
ROM Read Only Memory
RSRP Reference Transmission Receive Power
RSRQ Reference Transmission Receive Quality
RSSI Received Transmission Strength Indicator
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment

Further, various technical terms are used throughout this description. An illustrative resource that fleshes out various aspects of these terms can be found in Newton's Telecom Dictionary, 25th Edition (2009).

As used herein, the term “node” is used to refer to network access technology, such as eNode, gNode, etc. In other aspects, the term “node” may be used to refer to one or more antennas being used to communicate with a user device.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., cell sites, cell towers) to provide network coverage. The base stations are employed to broadcast and transmit transmissions to user devices of the telecommunications network. An access point may be considered to be a portion of a base station that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, a base station may comprise one access point or more than one access point. Factors that can affect the telecommunications transmission include, e.g., location and size of the base stations, and frequency of the transmission, antenna array configuration corresponding to both the access point and the UE, among other factors. The base stations are employed to broadcast and transmit transmissions to user devices of the telecommunications network.

As employed herein, a UE (also referenced herein as a user device) or WCD can include any device employed by an end-user to communicate with a wireless telecommunications network. A UE can include a mobile device, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

In conventional cellular communications technology, one of the most reliable and simple ways of authenticating subscribers in mobile networks is through the insertion of subscriber information, such as the Mobile Station Integrated Services Digital Network (MSISDN) or an International Mobile Subscriber Identity (IMSI), in HTTP transactions. This is done by the Mobile Core Network's Packet Gateway network element. Since this subscriber information is transmitted to and stored in the gateway during data session establishment, which is done following a rigorous authentication procedure by the network, the gateway is considered a reliable source of that information for a given data session. However, this process is limited to HTTP transactions only (i.e., transactions whose contents are in plain text).

Due to the web industry transitioning from plain text HTTP to more secured HTTPS transactions, this header insertion process is becoming obsolete. Operators are now developing alternative solutions, such as REST API exposure, to pass subscriber information to trusted partners. However, these API based solutions are faced with challenges and come with limited effectiveness due to the inherent design of communications networks for security and practical purposes. Specifically, Network Address Translators (NAT) hinder the API based solution's effectiveness. Moreover, end-to-end transactions over these API based type of solutions are much less efficient and take a longer time to complete due to multiple table lookups.

The present disclosure is directed to transmitting subscriber information via HTTPS. More particularly, in aspects set forth herein, systems and methods allow mobile operators to pass subscriber information from the core network's gateway network element to trusted partners for HTTPS transactions. As a result, subscriber information can be shared with trusted partners for all types of data sessions, including those that go through a NAT node. Initially, upon a UE initiating an HTTPS transaction to a server, the gateway reads an SNI header of the HTTPS transaction or a destination IP address of the server. If the SNI header or the destination IP address in the HTTPS transaction matches a pre-configured SNI header or destination IP address that requires subscriber information, the gateway copies a portion of an HTTPS message corresponding to the HTTPS transaction. The gateway initiates a secured connection to the server via HTTPS and forwards the subscriber information to the server, including the portion of the HTTPS message used to correlate the subscriber information to the original HTTPS transaction. Upon successfully correlating the subscriber information to the original HTTPS transaction, an acknowledgement is received that the HTPPS transaction is successful.

A first aspect of the present disclosure is directed to a method for transmitting subscriber information via HTTPS. The method comprises establishing, at a gateway, a session with a user equipment (UE), wherein the gateway receives and stores subscriber information corresponding to a subscriber associated with the UE. The method also comprises, upon the UE making an HTTPS transaction to the web or application server, reading, by the gateway, a server name indication (SNI) header within a Client Hello of the HTTPS transaction or a destination IP address of a web or application server. The method further comprises, upon the SNI header or the destination IP address in the HTTPS transaction matching a pre-configured SNI or destination IP address in the gateway, reading and copying, by the gateway, a portion of an HTTPS message corresponding to the HTTPS transaction. The method also comprises, upon the gateway initiating a successful HTTPS connection to the web or application server, forwarding, by the gateway, the subscriber information to the web or application server, the subscriber information including the portion of the HTTPS message.

A second aspect of the present disclosure is directed to one or more computer storage media having computer-executable instructions embodied thereon that, when executed by at least one computing device, cause the computing device to perform operations for transmitting subscriber information via HTTPS. The operations comprise establishing, at a gateway, a session with a user equipment (UE), wherein the gateway receives and stores subscriber information corresponding to a subscriber associated with the UE. The operations also comprise, upon the UE making an HTTPS transaction to the web or application server, reading, by the gateway, a server name indication (SNI) header within a Client Hello of the HTTPS transaction or a destination IP address of a web or application server. The operations further comprise, upon the SNI header or the destination IP address in the HTTPS transaction matching a pre-configured SNI or destination IP address in the gateway, reading and copying, by the gateway, a portion of an HTTPS message corresponding to the HTTPS transaction. The operations also comprise, upon the gateway initiating a successful HTTPS connection to the web or application server, forwarding, by the gateway, the subscriber information to the web or application server, the subscriber information including the portion of the HTTPS message.

Another aspect of the present disclosure is directed to a system for transmitting subscriber information via HTTPS. The system comprises one or more UEs and a node configured to wirelessly communicate with the one or more UEs. The node is configured to establish, at a gateway, a session with a UE of the one or more UEs, wherein the gateway receives and stores subscriber information corresponding to a subscriber associated with the UE. The node is also configured to, upon the UE making an HTTPS transaction to the web or application server, read, by the gateway, a server name indication (SNI) header within a Client Hello of the HTTPS transaction or a destination IP address of a web or application server. The node is further configured to, upon the SNI header or the destination IP address in the HTTPS transaction matching a pre-configured SNI or destination IP address in the gateway, read and copy, by the gateway, a portion of an HTTPS message corresponding to the HTTPS transaction, the portion comprising one or more of: a Transport Layer Security (TLS) session identification (ID), a TLS random number, or an IP tuple. The node is also configured to, upon the gateway initiating a successful HTTPS connection to the web or application server, forward, by the gateway, the subscriber information to the web or application server, the subscriber information including the portion of the HTTPS message.

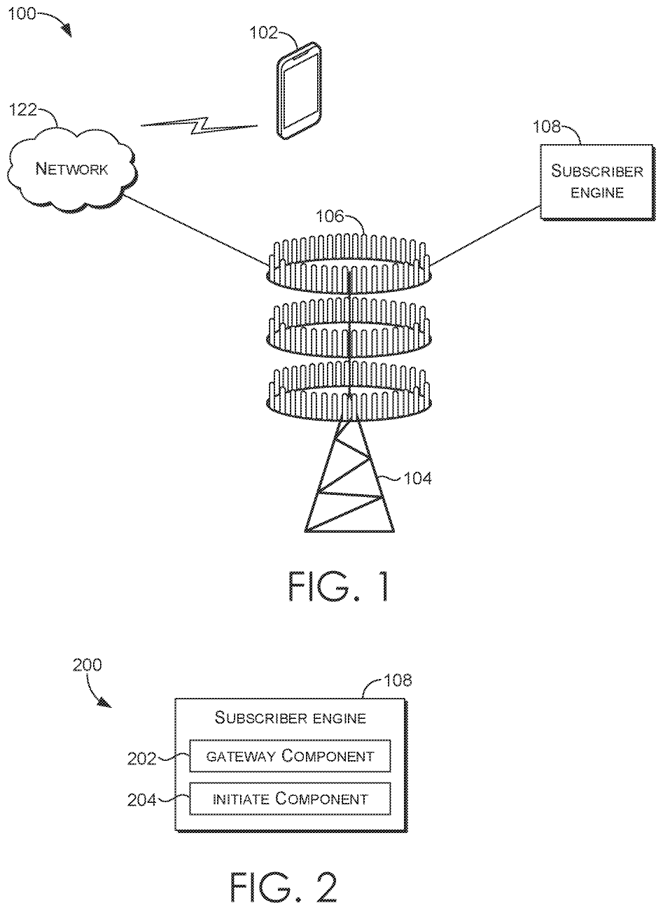

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

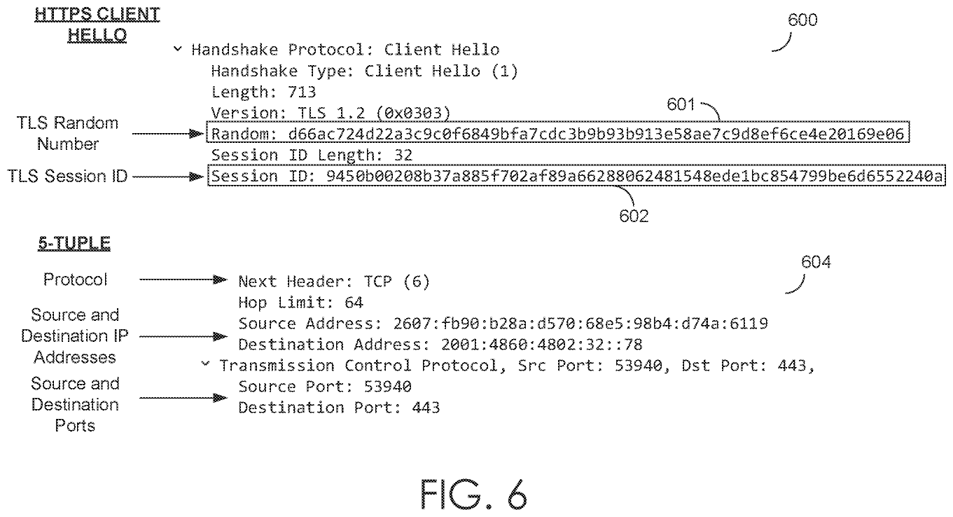

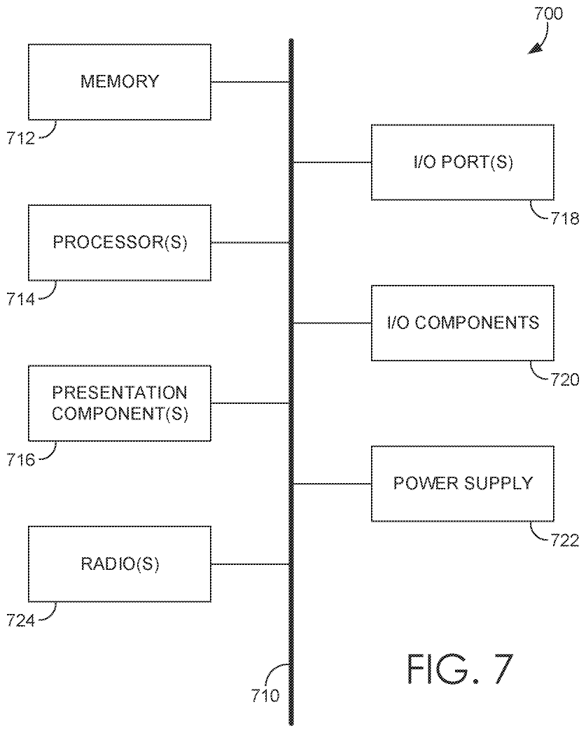

A network cell may comprise a base station to facilitate wireless communication between a communications device within the network cell, such as communications device 600 described with respect to FIG. 6, and a network. As shown in FIG. 1, a communications device may be a UE 102. In the network environment 100, UE 102 may communicate with other devices, such as mobile devices, servers, etc. The UE 102 may take on a variety of forms, such as a personal computer, a laptop computer, a tablet, a netbook, a mobile phone, a Smart phone, a personal digital assistant, or any other device capable of communicating with other devices. For example, the UE 102 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 102 comprises a wireless or mobile device with which a wireless telecommunication network(s) can be utilized for communication (e.g., voice and/or data communication). In this regard, the UE 102 can be any mobile computing device that communicates by way of, for example, a 5G network.

The UE 102 may utilize network 122 to communicate with other computing devices (e.g., mobile device(s), a server(s), a personal computer(s), etc.). In embodiments, network 122 is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. Network 122 may include multiple networks, as well as being a network of networks, but is shown in more simple form so as to not obscure other aspects of the present disclosure. Network 122 may be part of a telecommunications network that connects subscribers to their immediate service provider. In embodiments, network 122 is associated with a telecommunications provider that provides services to user devices, such as UE 102. For example, network 122 may provide voice services to user devices or corresponding users that are registered or subscribed to utilize the services provided by a telecommunications provider. Although it is contemplated network 122 can be any communication network providing voice and/or data service(s), such as, for example, a 1×circuit voice, a 3G network (e.g., CDMA, CDMA1000, WCDMA, GSM, UMTS), a 4G network (WiMAX, LTE, HSDPA), or the like, network 122 is depicted in FIG. 1 as a 5G network.

The network environment 100 may include a database (not shown). The database may be similar to the memory component 612 in FIG. 6 and can be any type of medium that is capable of storing information. The database can be any collection of records (e.g., network or device information). In one embodiment, the database includes a set of embodied computer-executable instructions that, when executed, facilitate various aspects disclosed herein. These embodied instructions will variously be referred to as “instructions” or an “application” for short.

As previously mentioned, the UE 102 may communicate with other devices by using a base station, such as base station 104. In embodiments, base station 104 is a wireless communications station that is installed at a fixed location, such as at a radio tower, as illustrated in FIG. 1. The radio tower may be a tall structure designed to support one or more antennas 106 for telecommunications and/or broadcasting. In other embodiments, base station 104 is a mobile base station. The base station 104 may be an MMU and include gNodeB for mMIMO/5G communications via network 122. In this way, the base station 104 can facilitate wireless communication between UE 102 and network 122.

As stated, the base station 104 may include a radio (not shown) or a remote radio head (RRH) that generally communicates with one or more antennas associated with the base station 104. In this regard, the radio is used to transmit signals or data to an antenna 106 associated with the base station 104 and receive signals or data from the antenna 106. Communications between the radio and the antenna 106 can occur using any number of physical paths. A physical path, as used herein, refers to a path used for transmitting signals or data. As such, a physical path may be referred to as a radio frequency (RF) path, a coaxial cable path, cable path, or the like.

The antenna 106 is used for telecommunications. Generally, the antenna 106 may be an electrical device that converts electric power into radio waves and converts radio waves into electric power. The antenna 106 is typically positioned at or near the top of the radio tower as illustrated in FIG. 1. Such an installation location, however, is not intended to limit the scope of embodiments of the present invention. The radio associated with the base station 104 may include at least one transceiver configured to receive and transmit signals or data.

Continuing, the network environment 100 may further include a Subscriber Engine 108. The Subscriber Engine 108 may be configured to, among other things, providing radio base station performance measurements with enhanced granularity, in accordance with the present disclosure. Though Subscriber Engine 108 is illustrated as a component of base station 104 in FIG. 1, it may be a standalone device (e.g., a server having one or more processors), a component of the UE 102, a service provided via the network 122, or may be remotely located.

Referring now to FIG. 2, the Subscriber Engine 108 may include, among other things, gateway component 202 and initiate component 204. Generally, the Subscriber Engine 108 allows subscriber information to be communicated from the core network's gateway network element to trusted partners for HTTPS transactions. As a result, subscriber information can be shared with trusted partners for all types of data sessions, including those that go through a NAT node.

Gateway component 202 generally establishes, at a gateway, a session with a UE. The gateway receives and stores subscriber information, at the gateway, corresponding to a subscriber associated with the UE. Upon the UE making an HTTPS transaction to a web or application server, gateway component 202 reads a SNI header within a Client Hello of the HTTPS transaction or a destination IP address of the web or application server. In some aspects, the web or application server is pre-configured to accept HTTPS transactions from the gateway. The gateway component 202 further attempts to match the SNI header or the destination IP address in the HTTPS transaction to a pre-configured SNI or destination IP address.

Upon determining a match, the gateway component 202 reads and copies a portion of the HTTPS message corresponding to the HTTPS transaction. The portion may comprises one or more of: a TLS session identification (ID), a TLS random number, or an IP tuple. In some aspects, gateway component 202 compares the portion of the HTTPS message to the HTTPS transaction made by the UE. Based on the comparing, gateway component 202 may correlate the subscriber information to the HTTPS transaction made by the UE. In some aspects, upon successfully correlating the subscriber information to the original HTTPS transaction made by the UE, an acknowledgement may be received indicating that the HTPPS transaction is successful

Initiate component 204 generally forwards, upon the gateway initiating a successful HTTPs connection to the web or application server, the subscriber information to the web or application server. The subscriber information includes the portion of the HTTPS message. In some aspects, the initiate component initiates a second connection to the web or application server via HTTPS.

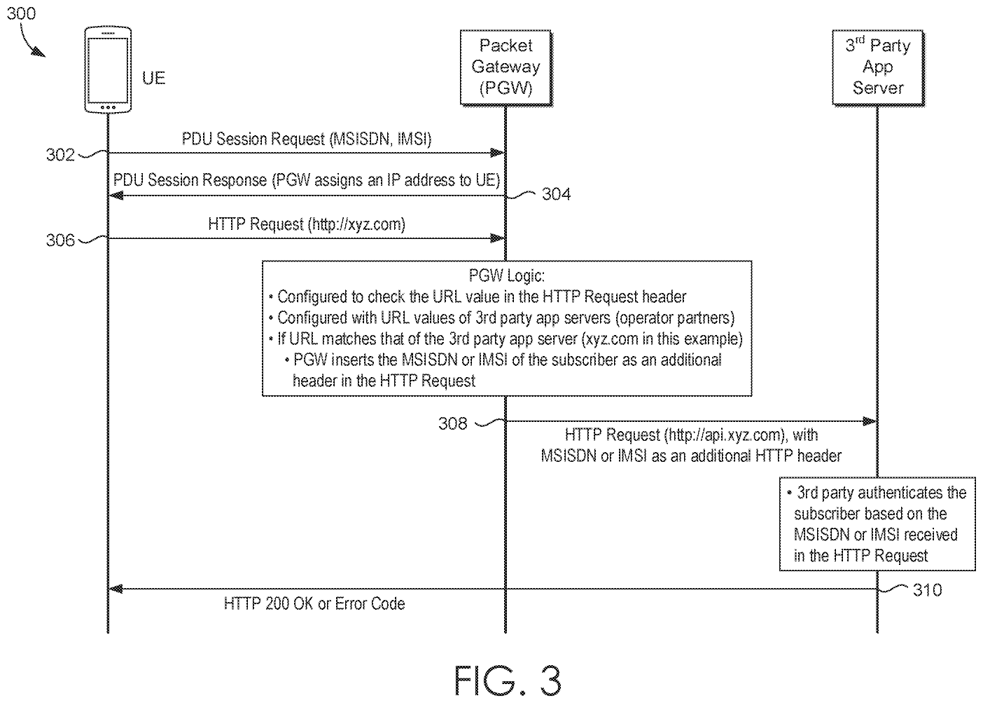

Turning to FIG. 3, a flow diagram is provided depicting a method 300 for a call flow for subscriber information transmission via HTTP header enrichment. As described above, insertion of subscriber information enables authentication of subscribers in a mobile network. Since this subscriber information is transmitted to and stored in the gateway during data session establishment, which may be done following a rigorous authentication procedure by the network, the gateway can be considered a reliable source of subscriber information for a given data session.

To illustrate, at step 302, a UE establishes a packet data unit (PDU) session request to packet gateway (PGW). The PDU session request includes a MSISDN or an IMSI identifying the UE to the PGW. At step 304, a PDU session response is provided from the PGW to the UE. As part of the PDU session response, the PGW assigns an internet protocol (IP) address to the UE. Upon the UE communicating an HTTP Request (e.g., hap: corn), at step 306, the PGW performs a series of steps. First, the PGW is configured to check the uniform resource locator (URL) value in the HTTP request header. Second, the PGW attempts to match the URL with URLs of third party application servers (i.e., operator partners).

If the URL matches that of an operator partner (xyz.com in this example), the PGW inserts and communicates the HTTP request with the MSISDN or IMSI of the subscriber as an additional header in the HTTP request. At step 310, the operator partner authenticates the subscriber based on the MSISN or IMSI received in the HTTP request and communicates back to the UE an HTTP 200 OK or an error code. However, this process is limited to HTTP transactions only (i.e., transactions whose contents are in plain text). Due to the web industry transitioning from plain text HTTP to a more secured HTTPS transaction, this header insertion process is becoming obsolete.

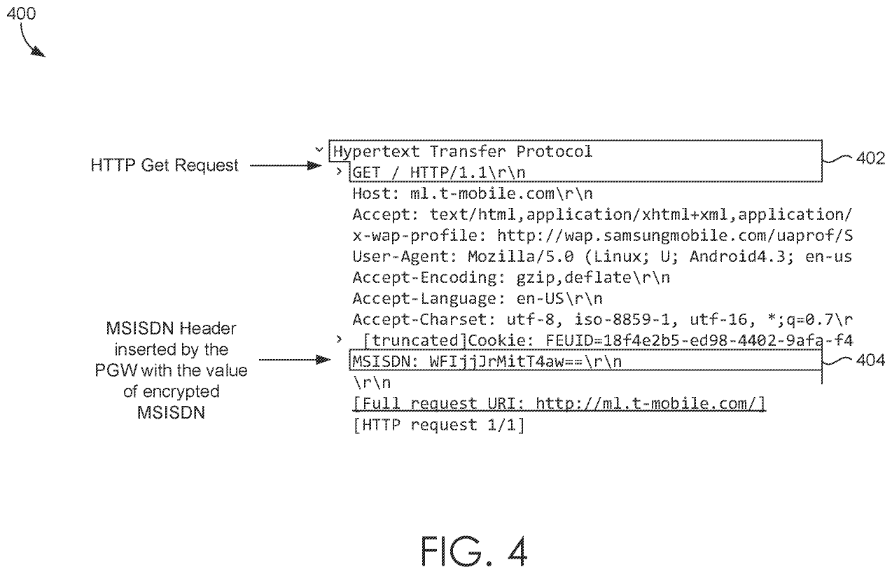

FIG. 4 depicts an HTTP header enrichment snapshot 400. As shown, the UE communicates the initial HTTP get request 402 to the PGW. If the URL matches that of an operator partner, the PGW inserts the encrypted MSISDN of the UE as an additional header 404 in the HTTP request.

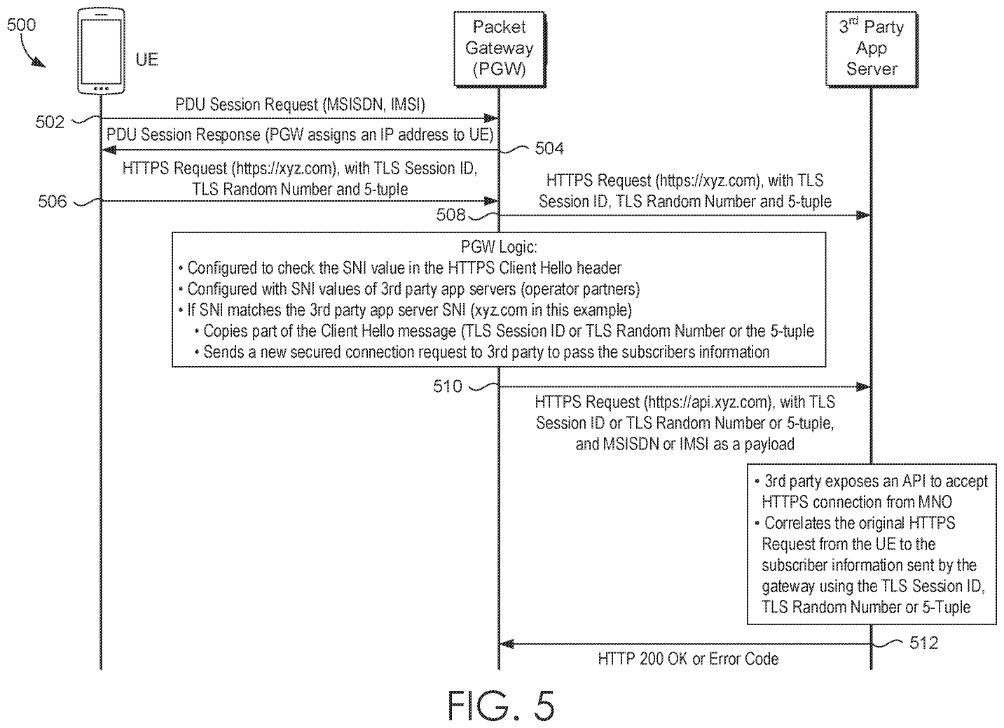

Referring now to FIG. 5, a flow diagram is provided depicting a method 500 for a call flow for subscriber information transmission via HTTPS header enrichment, in accordance with aspects herein. Initially, at step 302, a UE establishes a PDU session request to PGW. The PDU session request includes a MSISDN or an IMSI identifying the UE to the PGW. In some aspects, the MSISDN or IMSI is stored in the PGW. The PGW may also be configured to detect the server name indication (SNI) or the destination IP address of the web or application server that requires the subscriber information.

At step 504, a PDU session response is provided from the PGW to the UE. As part of the PDU session response, the PGW assigns an IP address to the UE. At step 506, the UE communicates an HTTPS request (e.g., https://xyz.com) to the PGW. The HTTPS request includes a TLS Session ID, a TLS random number, and a 5-tuple. The PGW communicates, at step 508, the HTTPS request with the TLS Session ID, the TLS random number, and the 5-tuple to the third party application server.

At step 510, the PGW performs a series of steps. First, the PGW is configured to check the SNI value in the HTTPS Client Hello header. Second, the PGW attempts to match the SNI with SNIs of third party application servers (i.e., operator partners). If the SNI matches that of an operator partner (xyz.com in this example), the PGW copies part of the Client Hello message (TLS Session ID or TLS random number, or the 5-tuple) and sends a new secured connection request to the operator partner to pass the subscriber information. The operator partner exposes an API to accept the new secured connection request from the mobile network operator. Using the TLS Session ID, the TLS random number, or the 5-tuple, the operator partner attempts to correlate the original HTTPS request from the UE to the subscriber information sent by the PGW. At step 512, based on the attempted correlation, the operator partner communicates a successful connection (e.g., by sending an HTTP 200 OK message) or an error code (e.g., 404 Not Found response).

FIG. 6 depicts an HTTPS Client Hello message 600 comprising a TLS random number 601 and a TLS session ID 602. The Client Hello message 600 may also include a 5-tuple 604. As described above, the operator partner may use the TLS Session ID, the TLS random number, or the 5-tuple in the new secured connection request sent by the PGW to attempt to correlate the TLS Session ID, the TLS random number, or the 5-tuple in the original HTTPS request. If the attempted correlation is successful, the operator partner can authenticate the subscriber using the subscriber information provided in the new secured connection request sent by the PGW.

Embodiments of the technology described herein may be embodied as, among other things, a method, a system, or a computer-program product. Accordingly, the embodiments may take the form of a hardware embodiment, or an embodiment combining software and hardware. The present technology may take the form of a computer-program product that includes computer-useable instructions embodied on one or more computer-readable media. The present technology may further be implemented as hard-coded into the mechanical design of network components and/or may be built into a broadcast cell or central server.

Computer-readable media includes both volatile and non-volatile, removable and non-removable media, and contemplate media readable by a database, a switch, and/or various other network devices. Network switches, routers, and related components are conventional in nature, as are methods of communicating with the same. By way of example, and not limitation, computer-readable media may comprise computer storage media and/or non-transitory communications media.

Computer storage media, or machine-readable media, may include media implemented in any method or technology for storing information. Examples of stored information include computer-useable instructions, data structures, program modules, and other data representations. Computer storage media may include, but are not limited to, RAM, ROM, EEPROM, flash memory or other memory technology, CD-ROM, digital versatile discs (DVD), holographic media or other optical disc storage, magnetic cassettes, magnetic tape, magnetic disk storage, and/or other magnetic storage devices. These memory components may store data momentarily, temporarily, and/or permanently, and are not limited to the examples provided.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Referring to FIG. 6, a block diagram of an exemplary computing device 600 suitable for use in implementations of the technology described herein is provided. In particular, the exemplary computer environment is shown and designated generally as computing device 600. Computing device 600 is but one example of a suitable computing environment and is not intended to suggest any limitation as to the scope of use or functionality of the invention. Neither should computing device 600 be interpreted as having any dependency or requirement relating to any one or combination of components illustrated. It should be noted that although some components in FIG. 6 are shown in the singular, they may be plural. For example, the computing device 600 might include multiple processors or multiple radios. In aspects, the computing device 600 may be a UE/WCD, or other user device, capable of two-way wireless communications with an access point. Some non-limiting examples of the computing device 600 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 6, computing device 600 includes a bus 610 that directly or indirectly couples various components together, including memory 612, processor(s) 614, presentation component(s) 616 (if applicable), radio(s) 624, input/output (I/O) port(s) 618, input/output (I/O) component(s) 620, and power supply(s) 622. Although the components of FIG. 6 are shown with lines for the sake of clarity, in reality, delineating various components is not so clear, and metaphorically, the lines would more accurately be grey and fuzzy. For example, one may consider a presentation component such as a display device to be one of I/O components 620. Also, processors, such as one or more processors 614, have memory. The present disclosure hereof recognizes that such is the nature of the art, and reiterates that FIG. 6 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 612 may take the form of memory components described herein. Thus, further elaboration will not be provided here, but it should be noted that memory 612 may include any type of tangible medium that is capable of storing information, such as a database. A database may be any collection of records, data, and/or information. In one embodiment, memory 612 may include a set of embodied computer-executable instructions that, when executed, facilitate various functions or elements disclosed herein. These embodied instructions will variously be referred to as “instructions” or an “application” for short.

Processor 614 may actually be multiple processors that receive instructions and process them accordingly. Presentation component 616 may include a display, a speaker, and/or other components that may present information (e.g., a display, a screen, a lamp (LED), a graphical user interface (GUI), and/or even lighted keyboards) through visual, auditory, and/or other tactile cues.

Radio 624 represents a radio that facilitates communication with a wireless telecommunications network. Illustrative wireless telecommunications technologies include CDMA, GPRS, TDMA, GSM, and the like. Radio 624 might additionally or alternatively facilitate other types of wireless communications including Wi-Fi, WiMAX, LTE, 3G, 4G, LTE, mMIMO/5G, NR, VoLTE, or other VoIP communications. As can be appreciated, in various embodiments, radio 624 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 618 may take a variety of forms. Exemplary I/O ports may include a USB jack, a stereo jack, an infrared port, a firewire port, other proprietary communications ports, and the like. Input/output (I/O) components 620 may comprise keyboards, microphones, speakers, touchscreens, and/or any other item usable to directly or indirectly input data into the computing device 600.

Power supply 622 may include batteries, fuel cells, and/or any other component that may act as a power source to supply power to the computing device 600 or to other network components, including through one or more electrical connections or couplings. Power supply 622 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method of transmitting subscriber information via HTTPS, the method comprising:
establishing, at a gateway, a session with a user equipment (UE), wherein the gateway receives and stores subscriber information corresponding to a subscriber associated with the UE;
upon the UE making an HTTPS transaction to a web or application server, reading, by the gateway, a server name indication (SNI) header within a Client Hello of the HTTPS transaction or a destination IP address of the web or application server;
upon the SNI header or the destination IP address in the HTTPS transaction matching a pre-configured SNI or destination IP address in the gateway, reading and copying, by the gateway, a portion of an HTTPS message corresponding to the HTTPS transaction; and
upon the gateway initiating a successful HTTPS connection to the web or application server, forwarding, by the gateway, the subscriber information to the web or application server, the subscriber information including the portion of the HTTPS message.

2. The method of claim 1, further comprising initiating, by the gateway, a secured connection to the web or application server via HTTPS.

3. The method of claim 1, wherein the portion comprises one or more of: a Transport Layer Security (TLS) session identification (ID), a TLS random number, or an IP tuple.

4. The method of claim 1, wherein the web or application server is pre-configured to accept HTTPS transactions from the gateway.

5. The method of claim 1, further comprising comparing the portion of the HTTPS message to the HTTPS transaction made by the UE.

6. The method of claim 5, further comprising, based on the comparing, correlating the subscriber information to the HTTPS transaction made by the UE.

7. The method of claim 6, further comprising, upon successfully correlating the subscriber information to the original HTTPS transaction made by the UE, receiving an acknowledgement, at the gateway that the HTPPS transaction is successful.

8. One or more computer storage media having computer-executable instructions embodied thereon that, when executed by at least one computing device, cause the computing device to perform operations for transmitting subscriber information via HTTPS, the operations comprising:
establishing, at a gateway, a session with a user equipment (UE), wherein the gateway receives and stores subscriber information corresponding to a subscriber associated with the UE;
upon the UE making an HTTPS transaction to a web or application server, reading, by the gateway, a server name indication (SNI) header within a Client Hello of the HTTPS transaction or a destination IP address of the web or application server;
upon the SNI header or the destination IP address in the HTTPS transaction matching a pre-configured SNI or destination IP address in the gateway, reading and copying, by the gateway, a portion of an HTTPS message corresponding to the HTTPS transaction; and
upon the gateway initiating a successful HTTPS connection to the web or application server, forwarding, by the gateway, the subscriber information to the web or application server, the subscriber information including the portion of the HTTPS message.

9. The computer storage media of claim 8, further comprising initiating, by the gateway, a secured connection to the web or application server via HTTPS.

10. The computer storage media of claim 8, wherein the portion comprises one or more of: a Transport Layer Security (TLS) session identification (ID), a TLS random number, or an IP tuple.

11. The computer storage media of claim 8, wherein the web or application server is pre-configured to accept HTTPS transactions from the gateway.

12. The computer storage media of claim 8, further comprising comparing the portion of the HTTPS message to the HTTPS transaction made by the UE.

13. The computer storage media of claim 12, further comprising, based on the comparing, correlating the subscriber information to the HTTPS transaction made by the UE.

14. The computer storage media of claim 13, further comprising, upon successfully correlating the subscriber information to the original HTTPS transaction made by the UE, receiving an acknowledgement, at the gateway that the HTPPS transaction is successful.

15. A system for transmitting subscriber information via HTTPS, the system comprising:
one or more UEs; and
anode configured to wirelessly communicate with the one or more UEs, wherein the node is configured to:
establish, at a gateway, a session with a UE of the one or more UEs, wherein the gateway receives and stores subscriber information corresponding to a subscriber associated with the UE;
upon the UE making an HTTPS transaction to a web or application server, read, by the gateway, a server name indication (SNI) header within a Client Hello of the HTTPS transaction or a destination IP address of the web or application server;
upon the SNI header or the destination IP address in the HTTPS transaction matching a pre-configured SNI or destination IP address in the gateway, read and copy, by the gateway, a portion of an HTTPS message corresponding to the HTTPS transaction, the portion comprising one or more of: a Transport Layer Security (TLS) session identification (ID), a TLS random number, or an IP tuple; and
upon the gateway initiating a successful HTTPS connection to the web or application server, forward, by the gateway, the subscriber information to the web or application server, the subscriber information including the portion of the HTTPS message.

16. The system of claim 15, further comprising initiating, by the gateway, a secured connection to the web or application server via HTTPS.

17. The system of claim 18, further comprising comparing the portion of the HTTPS message to the HTTPS transaction made by the UE.

18. The system of claim 17, further comprising, based on the comparing, correlating the subscriber information to the HTTPS transaction made by the UE.

19. The system of claim 18, further comprising, upon successfully correlating the subscriber information to the original HTTPS transaction made by the UE, receiving an acknowledgement, at the gateway that the HTPPS transaction is successful.

20. The system of claim 15, wherein the web or application server is pre-configured to accept HTTPS transactions from the gateway.
